(19) United States
(12) Patent Application Publication
(10) Pub. No.: US 2023/0294986 A1
(43) Pub. Date: Sep. 21, 2023

(54) METHOD AND APPARATUS FOR PRODUCING HYDROGEN GAS

(71) Applicants: HYUNDAI MOTOR COMPANY, SEOUL (KR); KIA CORPORATION, SEOUL (KR)

(72) Inventors: Han Eol SONG, Seongnam-si (KR); Woo Ram KANG, Suwon-si (KR)

(21) Appl. No.: 17/881,571

(22) Filed: Aug. 4, 2022

(30) Foreign Application Priority Data
Mar. 17, 2022 (KR) 10-2022-0033609

(51) Int. Cl. C01B 3/56

(52) U.S. Cl. CPC C01B 3/56; C01B 2203/0485

(57) ABSTRACT

Disclosed is an apparatus for producing a hydrogen gas, the apparatus including a desulfurizer that desulfurizes a hydrocarbon containing gas, a plasma reactor that generates the hydrogen containing gas from the desulfurized hydrocarbon containing gas through plasma based pyrolysis, a separator that separates a hydrogen gas from the hydrogen containing gas, and a heat exchanger that exchanges heat between at least one of the hydrocarbon containing gas at a front end of the desulfurizer and the desulfurized hydrocarbon containing gas at a rear end of the desulfurizer, the hydrogen gas being separated by the separator.

### CROSS-REFERENCE TO RELATED APPLICATION

This application claims the benefit of priority to Korean Patent Application No. 10-2022-0033609, filed in the Korean Intellectual Property Office on Mar. 17, 2022, the entire contents of which are incorporated herein by reference.

### TECHNICAL FIELD

The present disclosure relates to a method for producing a hydrogen gas, which shows excellent energy efficiency by increasing a temperature of a material by utilizing wasted heat of the produced hydrogen gas, and a producing apparatus using the method.

### BACKGROUND

In recent years, hydrogen gas has been spotlighted as an eco-friendly energy source, and thus various methods for producing a hydrogen gas have been suggested. Among the methods for producing a hydrogen gas, a method for plasma-treating a hydrocarbon containing material is eco-friendly as it generates a small amount of side-products such as carbon dioxide. Generally, a material is converted into hydrogen and carbon (for example, carbon black) by decomposing the material in the method for producing a hydrocarbon using plasma. In detail, in the producing method, a plasma state of a high temperature is maintained by igniting air or a plasma gas with an electric arc in an interior of a plasma generator, and a hydrocarbon containing material is converted to hydrogen and carbon by bringing the hydrocarbon containing material into reaction with plasma. Then, because a startup/response time is rapid due to a self-heat of plasma and an internal reaction heat due to thermal decomposition, it is suitable for a large amount of the material and a property of the gas.

For example, Korean Patent No. 1594350 (Patent Document 1) discloses an apparatus for producing hydrogen by using steam plasma, including a steam plasma torch connected to a steam boiler and a microwave generator, a gasification reactor that generates a synthetic gas by bringing stream plasma-activated by microwaves of the microwave generator and powered coal into reaction with each other with flames of a plasma torch at a high temperature; and a heat recovery stream boiler that recovers heat from the synthetic gas of the gasification reactor. However, the conventional method or apparatus for producing hydrogen by using plasma in Patent document 1 requires an operation of additionally purifying carbon monoxide, dust, and the like, which are impurities, which are much included in a synthetic gas generated by using hydrocarbon in a solid state as a material, and has a low energy efficiency as wasted heat of the produced hydrogen gas is discharged to the air.

### SUMMARY

The present disclosure has been made to solve the above-mentioned problems occurring in the prior art while advantages achieved by the prior art are maintained intact.

An aspect of the present disclosure provides a method for producing a hydrogen gas, which does not require additional purification of hydrogen as a purity of the produced hydrogen is high and has excellent energy efficiency by utilizing wasted heat of the produced hydrogen, and a producing apparatus using the same.

The technical problems to be solved by the present disclosure are not limited to the aforementioned problems, and any other technical problems not mentioned herein will be clearly understood from the following description by those skilled in the art to which the present disclosure pertains.

The present disclosure provides an apparatus for producing a hydrogen gas, the apparatus including a desulfurizer that desulfurizes a hydrocarbon containing gas, a plasma reactor that generates the hydrogen containing gas from the desulfurized hydrocarbon containing gas through plasma based pyrolysis, a separator that separates a hydrogen gas from the hydrogen containing gas, and a heat exchanger that exchanges heat between at least one of the hydrocarbon containing gas at a front end of the desulfurizer and the desulfurized hydrocarbon containing gas at a rear end of the desulfurizer, and the hydrogen gas separated by the separator.

The present disclosure provides a method for producing a hydrogen gas, the method including desulfurizing a hydrocarbon containing gas, generating the hydrogen containing gas from the desulfurized hydrocarbon containing gas through plasma based pyrolysis, separating the hydrogen gas from the hydrogen containing gas, and exchanging heat between at least one of the hydrocarbon containing gas at a front end of the desulfurizer, in the desulfurizing, and the desulfurized hydrocarbon containing gas at a rear end of the desulfurizer, in the desulfurizing, and the hydrogen gas separated in the sulfurizing.

### BRIEF DESCRIPTION OF THE DRAWINGS

The above and other objects, features and advantages of the present disclosure will be more apparent from the following detailed description taken in conjunction with the accompanying drawings:

FIG. 1 is a flowchart of an apparatus for producing a hydrogen gas according to an embodiment of the present disclosure.

FIG. 2 is a flowchart of an apparatus for producing a hydrogen gas according to an embodiment of the present disclosure.

FIG. 3 is a flowchart of an apparatus for producing a hydrogen gas according to an embodiment of the present disclosure.

FIG. 4 is a flowchart of an apparatus for producing a hydrogen gas according to an embodiment of the present disclosure.

FIG. 5 is a flowchart of an apparatus for producing a hydrogen gas according to an embodiment of the present disclosure.

FIG. 6 is a flowchart of an apparatus for producing a hydrogen gas according to an embodiment of the present disclosure.

### DETAILED DESCRIPTION

Hereinafter, the present disclosure will be described in detail.

### Apparatus for Producing Hydrogen Gas

An apparatus for producing a hydrogen gas according to the present disclosure includes a desulfurizer, a plasma reactor, and a heat exchanger.

### Desulfurizer

The desulfurizer functions to remove sulfur (S) components from a hydrocarbon containing gas.

Generally, any device that may be used to remove sulfur components from the hydrocarbon containing gas may be used as the desulfurizer without any limitation. For example, the desulfurizer may be one, to which a general desulfurization method such as desulfurization through hydrogen purification, desulfurization using addition of acids, or desulfurization using addition of alkalis.

### Plasma Reactor

The plasma reactor generates a hydrogen containing gas by plasma-treating the desulfurized hydrocarbon containing gas.

The plasma based pyrolysis may be an operation of mixing the desulfurized hydrocarbon containing gas and plasma and bringing them into reaction with each other.

Then, any plasma that may be generally used when hydrogen is produced may be used as the plasma without any particular limitation, and for example, the plasma may be high-temperature plasma or low-temperature plasma. In detail, the plasma may be high-temperature plasma, and for example, a temperature of the plasma may be 800° C. to 50,000° C. As described above, when the high-temperature plasma is used when the plasma is treated, hydrogen production efficiency may be improved due to a high conversion rate.

Furthermore, the plasma, for example, may be microwave plasma, arc plasma, and the like.

The plasma reactor may include a plasma generating part that generates plasma, and a reaction part that mixes the desulfurized hydrocarbon containing gas and the plasma introduced from the plasma generating part and brings them into reaction with each other.

### Separator

The separator separates the hydrogen gas from the hydrogen containing gas. In detail, the separator may separate side-products including the hydrogen gas and carbon from the hydrogen containing gas.

The hydrogen gas separated by the separator is of a high temperature, and the apparatus for producing a hydrogen gas according to the present disclosure has excellent energy efficiency by using wasted heat of the hydrogen gas of the high temperature in preheating of the hydrocarbon containing gas that is a source material introduced into the plasma reactor.

### Heat Exchanger

The heat exchanger exchanges heat between the hydrogen gas separated by the separator, and at least one of the hydrocarbon containing gas at a front end of the desulfurizer, which is a source material that is introduced into the plasma reactor, and the desulfurized hydrocarbon containing gas at a rear end of the desulfurizer. Accordingly, a temperature of the hydrogen gas separated by the separator decreases, and a temperature of the hydrocarbon containing gas at the front end or the rear end of the desulfurizer increases. That is, the wasted heat of the hydrogen gas of a high temperature is used for preheating the hydrocarbon containing gas that is a material introduced into the plasma reactor.

The ‘hydrocarbon gas at the front end of the desulfurizer’ means the hydrocarbon containing gas before being introduced into the desulfurizer, and the ‘desulfurized hydrocarbon containing gas at the rear end of the desulfurizer’ means the desulfurized hydrocarbon containing gas discharged from the desulfurizer.

For example, the heat exchanger may include at least one of a first heat exchanger that exchanges heat between the hydrocarbon containing gas at a front end of the desulfurizer and the hydrogen gas of a high temperature, which is separated by the separator, and a second heat exchanger that exchanges heat between the desulfurized hydrocarbon containing gas at a rear end of the desulfurizer and the hydrogen gas of a high temperature, which is separated by the separator.

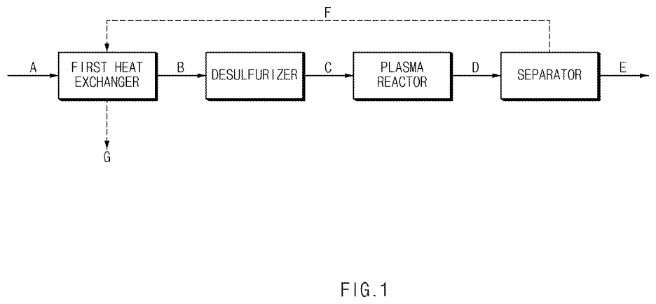

Referring to FIG. 1, the apparatus for producing a hydrogen gas according to the present disclosure may include a first heat exchanger that exchanges heat between the hydrocarbon containing gas “A” at the front end of the desulfurizer and the hydrogen gas “F” separated by the separator, a desulfurizer that desulfurizes the preheated hydrocarbon containing gas “B”, a plasma reactor that generates the hydrogen containing gas “D” from the desulfurized hydrocarbon containing gas “C” through plasma based pyrolysis, and a separator that separates the hydrogen gas “F” from the hydrogen containing gas “D”.

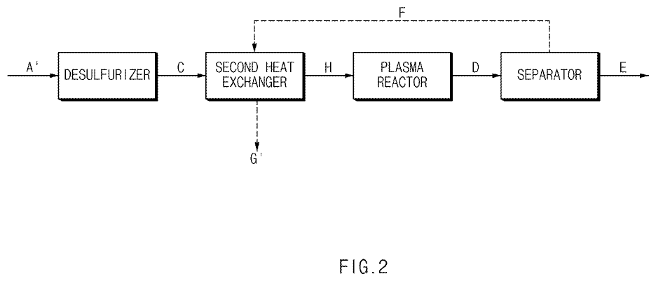

Referring to FIG. 2, the apparatus for producing a hydrogen gas according to the present disclosure may include a desulfurizer that desulfurizes the hydrocarbon containing gas A′, a second heat exchanger that exchanges heat between the desulfurized hydrocarbon containing gas “C” at the rear end of the desulfurizer and the hydrogen gas “F” separated by the separator, a plasma reactor that generates the hydrogen containing gas “D” from the hydrocarbon containing gas “H” that was desulfurized, exchanged heat, and was preheated, through plasma based pyrolysis, and a separator that separates the hydrogen gas “F” from the hydrogen containing gas “D”.

In detail, the heat exchanger includes a second heat exchanger that exchanges heat between the desulfurized hydrocarbon containing gas at the rear end of the desulfurizer and the hydrogen gas of a high temperature, which is separated by the separator; and a first heat exchanger that exchanges heat between the hydrogen gas discharged after exchanging heat in the second heat exchanger, and the hydrocarbon containing gas at the front end of the desulfurizer.

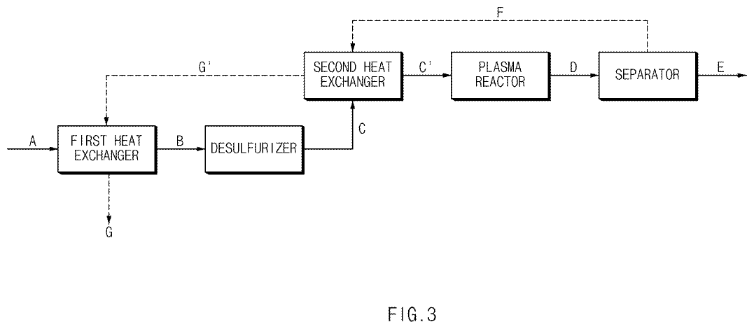

Referring to FIG. 3, the apparatus for producing a hydrogen gas according to the present disclosure may include a first heat exchanger that exchanges heat between the hydrocarbon containing gas “A” at the front end of the desulfurizer and the hydrogen gas G′ discharged after exchanging heat in the second heat exchanger, a desulfurizer that desulfurizes the preheated hydrocarbon containing gas “B”, a second heat exchanger that exchanges heat between the desulfurized hydrocarbon containing gas “C” and the hydrogen gas “F” separated by the separator, a plasma reactor that generates a hydrogen containing gas “D” from the desulfurized hydrocarbon containing gas C′ that was discharged after exchanging heat in the second heat exchanger, through plasma based pyrolysis, and a separator that separates the hydrogen gas “F” from the hydrogen containing gas “D”.

Then, reference numeral “E” denotes the side-products separated by the separator, and reference numerals “G” and G′ denote the hydrogen gas discharged after exchanging heat. The side-products “E” may include carbon.

The apparatus for producing a hydrogen gas according to the present disclosure may further include an adsorber that purifies the hydrogen gas that was discharged after exchanging heat in the heat exchanger.

### Adsorber

The adsorber purifies the hydrogen gas that exchanged heat in the heat exchanger. Then, the adsorber may separate the hydrogen gas that exchanged heat in the heat exchanger to the high-purity hydrogen gas and a first off gas through adsorption.

Any device that may generally remove impurities in the hydrogen gas may be used as the adsorber without particular limitation, and for example, may be performed through pressure swing adsorption (PSA).

The adsorber may include four to twelve adsorption towers, and the adsorption towers may be filled with an adsorption agent, and then, the adsorption agent, for example, may include a carbon-based material, a zeolite-based material, and the like, and in detail, may include activated carbon, aluminosilicate, pure silicate, titanosilicate, and aluminophosphate.

The apparatus for producing a hydrogen gas according to the present disclosure may further include a cooler that cools the hydrogen gas discharged after exchanging heat in the heat exchanger before the hydrogen gas is introduced into the adsorber, and a compressor that compresses the hydrogen gas cooled by the cooler.

### Cooler and Compressor

The cooler functions to increase adsorption efficiency by cooling the hydrogen gas that was discharged after exchanging heat in the heat exchanger.

Furthermore, any device that may lower the temperature of the hydrogen gas may be used without any particular limitation, and for example, may be a heat exchange type cooler. Then, the heat exchange type cooler may cool the hydrogen gas by exchanging heat between a refrigerant and the hydrogen gas, and the refrigerant, for example, may include water, an antifreeze, and a thermal medium oil.

The compressor functions to increase an adsorption effect by compressing the hydrogen gas cooled by the cooler. When the performance of the adsorber is made by the PSA, the adsorption effect of the impurities in the hydrogen gas becomes lower when the pressure of the supplied hydrogen gas becomes lower. Accordingly, the hydrogen gas introduced into the adsorber may be compressed by the compressor.

Furthermore, any device that may be used to generally compress the hydrogen gas may be used as the compressor without any particular limitation.

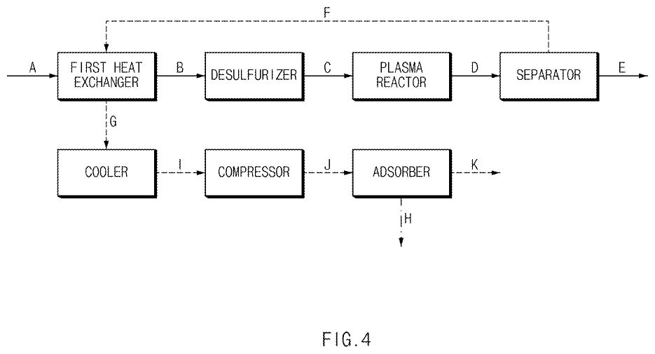

Referring to FIG. 4, the apparatus for producing a hydrogen gas according to the present disclosure may include a first heat exchanger that exchanges heat between the hydrocarbon containing gas “A” at the front end of the desulfurizer and the hydrogen gas “F” separated by the separator, a desulfurizer that desulfurizes the preheated hydrocarbon containing gas “B”, a plasma reactor that generates the hydrogen containing gas “D” from the desulfurized hydrocarbon containing gas “C” through plasma based pyrolysis, a separator that separates the side-products “E” including the hydrogen gas “F” and carbon from the hydrogen containing gas “D”, a cooler that cools the hydrogen gas “G” that was discharged after exchanging heat in the first exchanger, a compressor that compresses the hydrogen gas “I” cooled by the cooler, and an adsorber that purifies the hydrogen gas “J” compressed by the compressor band separates the high-purity hydrogen gas “H” and the off gas “K”.

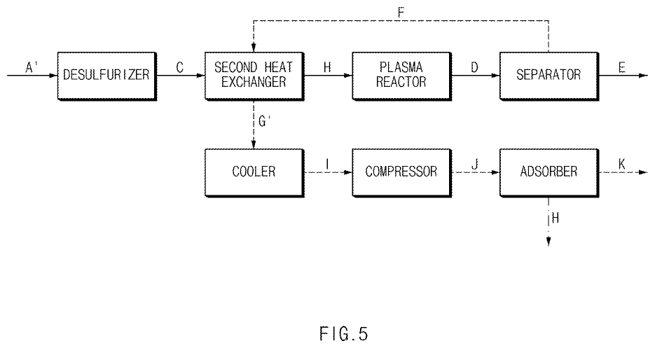

Referring to FIG. 5, the apparatus for producing a hydrogen gas according to the present disclosure may include a desulfurizer that desulfurizes the hydrocarbon containing gas A′, a second heat exchanger that exchanges heat between the desulfurized hydrocarbon containing gas “C” at the rear end of the desulfurizer and the hydrogen gas “F” separated by the separator, a plasma reactor that generates the hydrogen containing gas “D” from the hydrocarbon containing gas “H” that was desulfurized, exchanged heat, and was preheated, through plasma based pyrolysis, a separator that separates the side-products “E” including the hydrogen gas “F” and carbon from the hydrogen containing gas “D”, a cooler that cools the hydrogen gas G′ that was discharged after exchanging heat in the second exchanger, a compressor that compresses the hydrogen gas “I” cooled by the cooler, and an adsorber that purifies the hydrogen gas “J” compressed by the compressor band separates the high-purity hydrogen gas “H” and the off gas “K”.

The apparatus for producing a hydrogen gas may further include a flare stack that burns and discharges the off gas.

### Flare Stack

The off gas may be burned in the flare stack and be discharged to the air. Then, any device that may be applied to generally burn a gas and discharge the gas to the air may be applied as the flare stack without particular limitation.

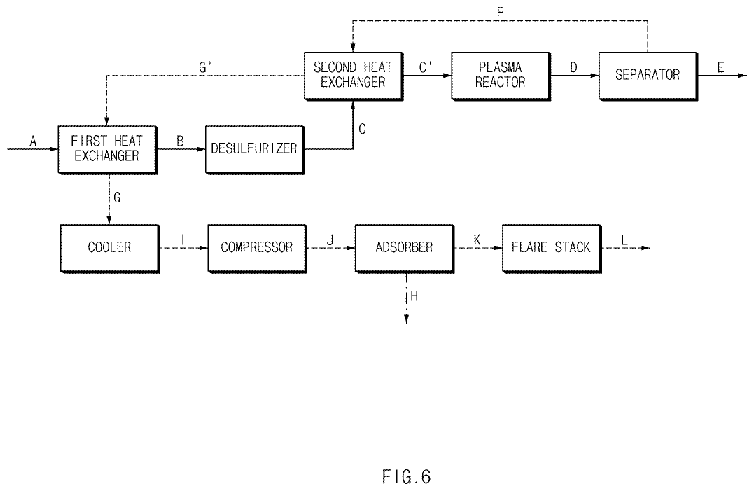

Referring to FIG. 6, the apparatus for producing a hydrogen gas according to the present disclosure may include a first heat exchanger that exchanges heat between the hydrocarbon containing gas “A” at the front end of the desulfurizer and the hydrogen gas G′ that exchanged heat in the second heat exchanger, a desulfurizer that desulfurizes the preheated hydrocarbon containing gas “B”, a second heat exchanger that exchanges heat between the desulfurized hydrocarbon containing gas “C” and the hydrogen gas “F” separated by the separator, a plasma reactor that generates the hydrogen containing gas “D” from the desulfurized hydrogen containing gas C′ discharged after exchanging heat in the second heat exchanger, through plasma based pyrolysis, a separator that separates the hydrogen containing gas “D” to the hydrogen gas “F” and the side-products “E” including carbon, a cooler that cools the hydrogen gas “G” that exchanged heat in the first heat exchanger, a compressor that compresses the hydrogen gas “I” cooled by the cooler, an adsorber that purifies the hydrogen gas “J” compressed by the compressor and separates the high-purity hydrogen gas “H” and the off gas “K”, and a flare stack that burns the off gas “K” and discharges the burned off gas to the air.

Furthermore, the hydrogen gas “K” that is adsorbed by the adsorber and is discharged may have a purity that is as high as 99.97% or more and may be used as a source material, for example, of a fuel cell without any additional purification.

### Method for Producing Hydrogen Gas

A method for producing a hydrogen gas according to the present disclosure includes a desulfurization operation, a plasma reaction operation, a separation operation, and a heat exchanging operation.

### Desulfurization Operation

In the operation, the hydrocarbon containing gas is desulfurized.

Generally, an operation that may be used to remove sulfur components from the hydrocarbon containing gas may be used as the desulfurization operation without any particular limitation. For example, the desulfurization operation may be one to which a general desulfurization method such as desulfurization through hydrogen purification, desulfurization using addition of acids, or desulfurization using addition of alkalis.

Plasma Reaction Operation

In the operation, the hydrogen containing gas is generated from the desulfurized hydrocarbon containing gas through plasma based pyrolysis.

The plasma based pyrolysis may be an operation of mixing the desulfurized hydrocarbon containing gas and plasma and bringing them into reaction with each other. Then, the plasma used during the plasma based pyrolysis is as described in the plasma reactor.

### Separation Operation

In the operation, the hydrogen gas is separated from the hydrogen containing gas. In detail, in the separation operation, side-products including the hydrogen gas and carbon may be separated from the hydrogen containing gas.

A temperature of the hydrogen gas in the separation operation may be 500° C. to 2,500° C. or 800° C. to 2,000° C., in certain embodiments. That is, the hydrogen gas separated in the separation operation is of a high temperature. The method for producing a hydrogen gas according to the present disclosure has an excellent energy efficient by using the wasted heat of the hydrogen gas of a high temperature, which is a material that is introduced in the plasma reaction operation, for heating the hydrocarbon containing gas.

### Heat Exchanging Operation

In the operation, heat is exchanged between the hydrogen gas separated in the separation operation, and at least one of the hydrocarbon containing gas at a front end of the desulfurizer, in the desulfurization operation, and the desulfurized hydrocarbon containing gas at a rear end of the desulfurizer, in the desulfurization operation. Accordingly, a temperature of the hydrogen gas separated in the separation operation decreases, and a temperature of the hydrocarbon containing gas at the front end or the rear end of the desulfurizer in the desulfurization operation increases. That is, the wasted heat of the hydrogen gas of a high temperature is used for preheating the hydrocarbon containing gas that is a source material introduced into the plasma reaction operation.

The ‘hydrocarbon gas at the front end in the desulfurization operation’ means the hydrocarbon containing gas before being introduced in the desulfurization operation, and the ‘desulfurized hydrocarbon containing gas at the rear end in the desulfurization operation’ means the desulfurized hydrocarbon containing gas discharged in the desulfurization operation.

For example, the heat exchanging operation may include at least one of exchanging heat between the hydrocarbon containing gas at a front end of the desulfurizer, in the desulfurization operation, and the hydrogen gas of a high temperature, which is separated in the separation operation, and exchanging heat between the desulfurized hydrocarbon containing gas at a rear end of the desulfurizer, in the desulfurization operation, and the hydrogen gas of a high temperature, which is separated in the heat exchanging operation.

In detail, the heat exchanging operation may include a first heat exchanging operation of exchanging heat between the desulfurized hydrocarbon containing gas at a rear end of the desulfurizer, in the desulfurization operation, and the hydrogen gas of a high temperature, which is separated in the separation operation, and a second heat exchanging operation of exchanging heat between the hydrogen gas discharged after exchanging heat in the heat exchanging operation, and the hydrocarbon containing gas at the front end in the desulfurization operation.

The method for producing a hydrogen gas according to the present disclosure may further include an adsorption operation of purifying the hydrogen gas discharged after exchanging heat in the heat exchanger, in the heat exchanging operation.

### Adsorption Operation

Any operation that may generally remove impurities in the hydrogen gas may be used as the operation without particular limitation, and for example, may be performed through pressure swing adsorption (PSA).

The adsorber and the adsorption method that may be applied to the adsorption operation are as described in the adsorber.

The method for producing a hydrogen gas according to the present disclosure may further include a cooling operation of cooling the hydrogen gas discharged after exchanging heat in the heat exchanging operation after the hydrogen gas is introduced in the adsorption operation, and a compression operation of compressing the hydrogen gas cooled in the cooling operation.

### Cooling Operation and Compression Operation

The cooling operation functions to increase adsorption efficiency by cooling the hydrogen gas that was discharged after exchanging heat in the heat exchanging operation.

In detail, a temperature of the hydrogen gas discharged after exchanging heat in the heat exchanging operation may be 150° C. to 1050° C. or 200° C. to 650° C., in certain embodiments. That is, the hydrogen gas that is discharged after exchanging heat in the heat exchanging operation is of a high temperature. Accordingly, the hydrogen gas that exchanged heat in the heat exchanging operation and was discharged may enhance adsorption efficiency by further providing the cooling operation that cools the hydrogen gas before adsorption.

The hydrogen gas cooled in the cooling operation may be 10° C. to 80° C. or 10° C. to 60° C., in certain embodiments. When the temperature of the cooled hydrogen gas is less than the range, economic efficiency may decrease due to excessive cooling, and when the temperature is more than the range, the adsorption agent filled in the adsorber may be damaged.

The compression operation functions to increase an adsorption effect by compressing the hydrogen gas cooled by the cooling operation. When the adsorption operation is performed by the PSA, the adsorption effect of the impurities in the hydrogen gas becomes lower when the pressure of the supplied hydrogen gas becomes lower. Accordingly, the hydrogen gas introduced in the adsorption operation may be compressed by the compressor.

Then, a pressure of the hydrogen gas compressed in the compression operation may be 0.5 MPa to 5.0 MPa or 1.0 MPa to 3.5 MPa, in certain embodiments. When the pressure of the compressed hydrogen gas is less than the range, the effect of adsorbing impurities in the hydrogen gas decreases, and when the pressure is more than the range, the adsorption agent filled in the adsorber may be damaged.

A purity of the hydrogen produced by the method for producing a hydrogen operation and the apparatus for producing a hydrogen gas according to the present disclosure, which has been described above, is as high as 99.97% or more, a fuel for a fuel cell and the like may be used without additional purification. Furthermore, the method for producing a hydrogen operation and the apparatus for producing the hydrogen gas have excellent energy efficiency because it uses the wasted heat of the produced hydrogen to prevent the material.

Hereinafter, the present disclosure will be described in more detail through the embodiments. However, the embodiments are provided simply to help understanding of the present disclosure and the scope of the present disclosure is not limited to the embodiments in any meaning.

### EMBODIMENT

### First Embodiment. Producing of Hydrogen Gas

A hydrogen gas was produced by using the apparatus for producing a hydrogen gas, which has the structure of FIG. 4. Then, a methane gas was used as the hydrocarbon containing gas “A” that is a source material, and a reactor was used as the plasma reactor by using microwave plasma of a high temperature of 1,000° C. or more. Furthermore, a heat exchange type cooler using cooling water was used as the cooler. Moreover, a temperature of the hydrogen gas “F” separated by the separator was 1,500±500° C., a temperature of the hydrogen gas “G” discharged after exchanging heat in the first heat exchanger was 500±150° C., and a temperature of the hydrogen gas “I” cooled by the cooler was 40±20° C. Furthermore, a pressure of the hydrogen gas “J” compressed by the compressor was 1.5MPa, and the adsorber included fourth adsorption towers filled with active carbon.

A system efficiency of the produced hydrogen gas was calculated through a method using hydrogen gas “H”/(electricity +hydrocarbon containing gas A) (an enthalpy-based calorie). Then, the apparatus were designed to suitable for ISO 14687, and the results are represented in Table 1.

### Second Embodiment

A hydrogen gas was produced by using the apparatus for producing a hydrogen gas, which has the structure of FIG. 5. Then, a methane gas was used as the hydrocarbon containing gas “A” that is a source material, and a method for calculating or measuring system efficiencies and purities of the produced hydrogen gases was the same as that of the first embodiment, and the results are represented in Table 1.

### Third Embodiment

A hydrogen gas was produced by using the apparatus for producing a hydrogen gas, which has the structure of FIG. 6. Then, a methane gas was used as the hydrocarbon containing gas “A” that is a source material, and a method for calculating or measuring system efficiencies and purities of the produced hydrogen gases was the same as that of the first embodiment, and the results are represented in Table 1.

### Comparative example 1

A hydrogen gas was produced through the same method as that of the first embodiment, except that the first heat exchanger and the second heat exchanger in FIG. 6 were not used, and the results are represented in Table 1.

TABLE 1

| | | Compar- | First | Second | Third |
|---|---|---|---|---|---|
| | | ative | Embodi- | Embodi- | Embodi- |
| | Unit | example 1 | ment | ment | ment |
| Feed gas | Nm³/hr | 133.7 | 133.7 | 133.7 | 133.7 |
| Electricity | kW | 370 | 345 | 349 | 324.2 |
| Consumption | | | | | |
| Product | kg/d | 430 | 430 | 430 | 430 |
| Hydrogen | | | | | |
| System | % | 39.4 | 40 | 40 | 40.4 |
| Efficiency of | | | | | |
| Hydrogen Gas | | | | | |

As may be seen in Table 1, the system efficiencies of the hydrogen gases of the first to third embodiments were as remarkably excellent as 40% or more as compared with Comparative Example 1, and the energy efficiencies thereof were excellent as the electricity consumption were low.

A purity of the hydrogen produced by the method for producing a hydrogen gas according to the present disclosure, which has been described above, is as high as 99.97% or more, a fuel for a fuel cell and the like may be used without additional purification. Furthermore, the method for producing the hydrogen gas has excellent energy efficiency because it uses the wasted heat of the produced hydrogen to prevent the material.

What is claimed is:

1. An apparatus for producing a hydrogen gas, the apparatus comprising:
a desulfurizer configured to desulfurize a hydrocarbon containing gas;
a plasma reactor configured to generate the hydrogen containing gas from the desulfurized hydrocarbon containing gas through plasma based pyrolysis;
a separator configured to separate a hydrogen gas from the hydrogen containing gas; and
a heat exchanger configured to exchange heat between at least one of the hydrocarbon containing gas at a front end of the desulfurizer and the desulfurized hydrocarbon containing gas at a rear end of the desulfurizer, and the hydrogen gas separated by the separator.

2. The apparatus of claim 1, wherein the heat exchanger includes at least one of:
a first heat exchanger configured to exchange heat between the hydrocarbon containing gas at a front end of the desulfurizer and the hydrogen gas of a high temperature, which is separated by the separator; and
a second heat exchanger configured to exchange heat between the desulfurized hydrocarbon containing gas at a rear end of the desulfurizer and the hydrogen gas of a high temperature, which is separated by the separator.

3. The apparatus of claim 1, wherein the heat exchanger includes:
a second heat exchanger configured to exchange heat between the desulfurized hydrocarbon containing gas at the rear end of the desulfurizer and the hydrogen gas of a high temperature, which is separated by the separator; and
a first heat exchanger configured to exchange heat between the hydrogen gas discharged after exchanging heat in the second heat exchanger, and the hydrocarbon containing gas at the front end of the desulfurizer.

4. The apparatus of claim 1, further comprising:
an adsorber configured to purify the hydrogen gas discharged after exchanging heat in the heat exchanger.

5. The apparatus of claim 4, wherein the adsorber performs pressure swing adsorption (PSA).

6. The apparatus of claim 4, further comprising:
a cooler configured to cool the hydrogen gas discharged after exchanging heat in the heat exchangers before the hydrogen gas is introduced into the adsorber; and
a compressor configured to compress the hydrogen gas cooled by the cooler.

7. A method for producing a hydrogen gas, the method comprising:
desulfurizing a hydrocarbon containing gas;
generating a hydrogen containing gas from the desulfurized hydrocarbon containing gas through plasma based pyrolysis;
separating the hydrogen gas from the hydrogen containing gas; and
exchanging heat between at least one of the hydrocarbon containing gas at a front end of the desulfurizer in the desulfurizing, and the desulfurized hydrocarbon containing gas at a rear end of the desulfurizer in the desulfurizing, and the hydrogen gas separated in the separating.

8. The method of claim 7, wherein a temperature of the hydrogen gas separated in the separating is in a range of 500° C. to 2,500° C., and
wherein a temperature of the hydrogen gas discharged after exchanging heat in the exchanging of the heat is in a range of 150° C. to 700° C.

9. The method of claim 7, wherein the exchanging of the heat includes at least one of:
exchanging heat between the hydrocarbon containing gas at a front end of the desulfurizer in the desulfurizing, and the hydrogen gas of a high temperature, which is separated in the separating; and
exchanging heat between the desulfurized hydrocarbon containing gas at a rear end of the desulfurizer in the desulfurizing, and the hydrogen gas of a high temperature, which is separated in the exchanging of the heat.

10. The method of claim 7, wherein the exchanging of the heat includes:
exchanging heat between the desulfurized hydrocarbon containing gas at a rear end of the desulfurizer in the desulfurizing, and the hydrogen gas of a high temperature, which is separated in the separating; and
exchanging heat between the hydrogen gas discharged after exchanging heat in the exchanging of the heat, and the hydrocarbon containing gas at the front end in the desulfurizing.

11. The method of claim 7, further comprising:
purifying the hydrogen gas discharged after exchanging heat in the heat exchanger, in the exchanging of the heat.

12. The method of claim 11, further comprising:
before the purifying,
cooling the hydrogen gas discharged after exchanging heat in the exchanging of the heat before the hydrogen gas is introduced in the purifying; and
compressing the hydrogen gas cooled in the cooling.

13. The method of claim 12, wherein a temperature of the hydrogen gas cooled in the cooling is in a range of 10° C. to 80° C., and
wherein a pressure of the hydrogen gas compressed in the compressing is in a range of 0.5 MPa to 5.0 MPa.

14. The method of claim 11, wherein a pressure swing adsorption (PSA) is performed in the adsorping.
